(19) United States
(12) Patent Application Publication
(10) Pub. No.: US 2009/0266788 A1
(43) Pub. Date: Oct. 29, 2009

(54) METHOD FOR FABRICATING CONDUCTIVE PATTERN ON FLEXIBLE SUBSTRATE AND PROTECTIVE INK USED THEREIN

(75) Inventors: Shinn-Jen CHANG, Hsinchu (TW); Feng-Mei Wu, Hsinchu City (TW); Wen-Hsuan Chao, Hsinchu (TW); Shih-Hsien Liu, Hsinchu County (TW)

Correspondence Address: LOWE HAUPTMAN HAM & BERNER, LLP, 1700 DIAGONAL ROAD, SUITE 300, ALEXANDRIA, VA, 22314, US

(73) Assignee: INDUSTRIAL TECHNOLOGY RESEARCH INSTITUTE, Hsinchu (TW)

(21) Appl. No.: 12/174,097

(22) Filed: Jul. 16, 2008

(30) Foreign Application Priority Data
Apr. 28, 2008 (TW) 97115536

(51) Int. Cl. C08L 75/00; H01B 13/00; C08L 37/00; C08L 27/00

(52) U.S. Cl. 216/17; 524/589; 524/548; 524/551

(57) ABSTRACT

The invention discloses a method for fabricating a conductive pattern on a flexible substrate. A flexible substrate having a conductive layer thereon is provided. A protective ink is screen printed on the conductive layer, wherein a portion of the conductive layer is exposed through the protective ink. The exposed portion of the conductive layer is removed by etching using the protective ink as a mask. The protective ink is then removed, thus providing a conductive pattern with a minimum line width of not greater than 150 μm. The invention also discloses a composition for the protective ink.

### CROSS REFERENCE TO RELATED APPLICATIONS

This Application claims priority of Taiwan Patent Application No. 97115536, filed on Apr. 28, 2008,the entirety of which is incorporated by reference herein.

### BACKGROUND OF THE INVENTION

1. Field of the Invention

The invention relates to a method of fabricating conductive patterns, and in particular to a method of fabricating conductive patterns on a flexible substrate by screen printing, and a protective ink used in the fabrication method.

2. Description of the Related Art

Research and development efforts focusing on flexible electronics is currently an area of rapid growth in the microelectronics industry. Flexible electronics is a technology for assembling electronic circuits by mounting electronic devices on flexible plastic substrates or metal foils instead of common rigid silicon or glass substrates, which allow the electronic devices to bend, flex, and conform to a desired shape during their use. Additionally, flexible electronic devices can be cost effectively manufactured, and enjoy advantages with regards to light weight, high impact resistance, and high degree of design freedom.

Flexible patterning is a key technology for implementing flexible electronics. As conventional patterning techniques for rigid substrates are not satisfactory for flexible substrates, there exists a need in the art for a novel patterning technique for flexible substrates.

Conventional screen printing ink is not suitable for making fine line features. Typically, screen printing is used for fabricating features larger than about 100 μm, while photolithography is used for fabricating features smaller than about 100 μm. However, a photolithography process requires several time consuming steps and high cost equipment, and thus, is not advantageous for mass production of flexible electronics. There have been attempts to make conductive patterns on flexible substrates by printing techniques. See for example, U.S. Patent Publication No. 20050163919, U.S. Patent Publication No. 20040157974, and Japanese Patent Publication No. 2002200833. However, conventional methods are either incapable of making fine line features or not suitable for use in a continuous roll-to-roll process. Accordingly, there remains a need in the art for a method for making fine line features on a flexible substrate, which is low cost and suitable for use in a continuous roll-to-roll process.

### BRIEF SUMMARY OF THE INVENTION

In one aspect, the invention provides a method for fabricating a conductive pattern on a flexible substrate, comprising: providing a flexible substrate having a conductive layer thereon; screen printing a protective ink on the conductive layer, wherein a portion of the conductive layer is exposed through the protective ink; etching to remove the exposed portion of the conductive layer using the protective ink as an etch mask; and removing the protective ink from reminder of the conductive layer, thus providing a conductive pattern, wherein the conductive pattern has a minimum line width of not greater than 150 μm.

In another aspect, the invention provides a protective ink, comprising: 10-80 parts by weight of a polymer resin; 0-5 parts by weight of an anti-tack agent; 0-3 parts by weight of a defoaming agent; 0.1-5 parts by weight of a leveling agent; 0.1-5 parts by weight of a thickening agent; and 20-90 parts by weight of a solvent, wherein the protective ink has a thixotropic index (TI) of about 1.1-5.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1-4 are cross sections illustrating the steps for fabricating a conductive pattern on a flexible substrate according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention provides a novel method of fabricating conductive patterns on a flexible substrate by screen printing, and also provides a protective ink for serving as an etch mask during the fabrication method. The fabrication method of the invention does not require complicated steps and the materials and equipments used are inexpensive and readily available, thus the fabrication method is very cost-effective. The printing ink is formulated by polymer resins and various additives to suite with a screen printing process for forming fine line features.

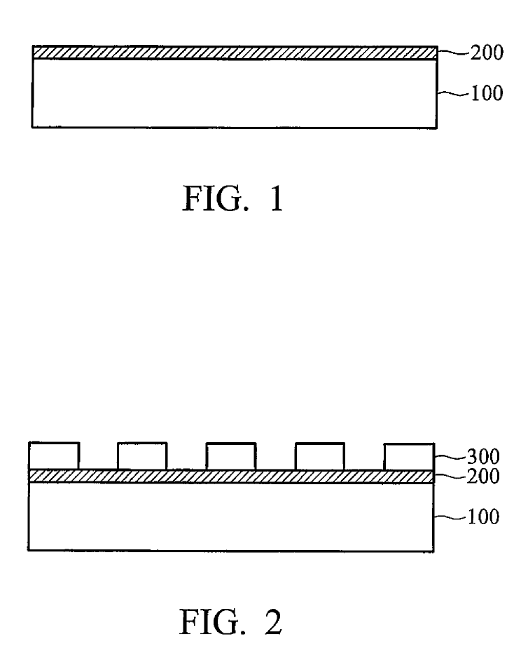

FIGS. 1-4 are cross sections illustrating the steps for fabricating a conductive pattern on a flexible substrate according to an embodiment of the invention. Referring to FIG. 1, a flexible substrate 100 having a conductive layer 200 thereon is provided. The flexible substrate 100 is preferably a plastic substrate. Plastic substrates include polyester, polyimide (PI), polycarbonate (PC), polyethylene (PE), polypropylene (PP), polyvinyl alcohol (PVA), polyvinyl phenol (PVP), poly(methylmethacrylate) (PMMA), poly(ethylene terephthalate) (PET), poly(ethylene naphthalate) (PEN), parylene, epoxy resin, polyvinyl chloride (PVC), and the like. In addition, the flexible substrate 100 can be any flexible materials other than plastics, such as organic/inorganic hybrid material, organic/inorganic composite, paper, non-woven fabric, cloth, thin glass, sol gel or metallic foil.

The conductive layer 200 can be formed of metals, metal oxides, alloys thereof, or laminates thereof. Materials for the conductive layer 200 include, but are not limited to, copper, aluminum, gold, silver, nickel, titanium, platinum, tungsten, cobalt, tantalum, molybdenum, tin, indium tin oxide (ITO), indium zinc oxide (IZO), alloys thereof, or laminates thereof. In preferred embodiments, a flexible substrate with an already-formed conductive layer is used, for example, an ITO/PET substrate, a copper/PET substrate, and the like. The sheet resistance of the conductive layer 200 is not specifically limited, but is preferably within the range of 3-1000 ohms/square, more preferably 10-300 ohms/square.

Referring to FIG. 2, a protective ink 300 is screen printed onto the conductive layer 200 to provide a positive image of the desired conductive pattern. Namely, the protective ink 300 is printed on portions corresponding to the conductive pattern, leaving portions to be removed unprinted. The polymer resin, the additives, and the viscosity of the protective ink 300 are selected so that fine line features can be achieved by screen printing. Each component constituting the protective ink composition of the invention will be described in greater detail.

The protective ink of the invention may include: 10-80 parts by weight of a polymer resin, 0-5 parts by weight of an anti-tack agent, 0-3 parts by weight of a defoaming agent, 0.1-5 parts by weight of a leveling agent, 0.1-5 parts by weight of a thickening agent, and 20-90 parts by weight of a solvent. In preferred embodiments, the protective ink may include: 15-60 parts by weight of a polymer resin, 0-3 parts by weight of an anti-tack agent, 0-1.5 parts by weight of a defoaming agent, 0.1-3 parts by weight of a leveling agent, 0.1-3 parts by weight of a thickening agent, and 40-80 parts by weight of a solvent. It is to be noted that an amount for a component specified within a range starting with a value of zero, is an optional component, such as the anti-tack agent and the defoaming agent. That is, the component may either be absent or present in any amount above zero and below the upper limit of the respective range.

The polymer resin useful in the present invention includes epoxy resins, vinyl resins, polyurethane resins, thermoplastic polyurethane (TPU) elastomers, acrylic resins, or combinations thereof. Suitable epoxy resins include, but are not limited to, bisphenol A epoxy resins, bisphenol F epoxy resins, bisphenol S epoxy resins, phenol-novolak epoxy resins, cresol-novolak epoxy resins, alicyclic epoxy resins, or combinations thereof. Suitable vinyl resins include vinyl acetate polymer resins, vinyl chloride-vinyl acetate copolymer resins, vinyl chloride-vinyl acetate-maleic acid terpolymer resins, or combinations thereof. In one embodiment, the vinyl chloride-vinyl acetate-maleic acid terpolymer resin is composed of 81-90 molar % of vinyl chloride, 9-17 molar % of vinyl acetate, and 0.5-2 molar % of maleic acid. Suitable polyurethanes include thermoplastic polyurethane (TPU) elastomers and polyurethane (PU) resins. It should be noted that the above described resins may be used independently or as a mixture of two or more resins.

The solvent useful in the invention may be properly selected in accordance with the polymer resin used. For example, ether and ester solvents are particularly preferred when epoxy resins are used. Suitable ether solvents include, but are not limited to, propylene glycol monomethyl ether, ethyl ether, butyl cellosolve, glycol ethers, ethylene glycol monomethylether, tetrahydrofuran (THF), ethylene glycol monobutyl ether, and the like. Suitable ester solvents include, but are not limited to, propylene glycol monomethyl ether acetate, ethyl-2-ethoxyethanol acetate, ethyl 3-ethoxypropionate, isoamyl acetate, and the like. When vinyl resins are used, ester solvents are particularly preferred, for example, butyl acetate, butyl carbitol acetate, carbitol acetate, ethylene glycol monobutyl ether acetate (BCS acetate), and the like.

The additives used in the protective ink mainly comprise an anti-tack agent, a defoaming agent, a leveling agent, and a thickening agent. The anti-tack agent may be employed to prevent surface sticking and maintain free-flow properties. Suitable anti-tack agents include, but are not limited to, LYSURF LB-500R, LYSURF LB-50P, LYSURF CST-50, LYSURF HW-25, and LYSURF LB-241D, all from LYSURF CHEMICAL Co. The defoaming agent may be employed to eliminate ink air bubbles, which adversely affect the resolution of the resulting pattern. Suitable defoaming agents include, but are not limited to, LYSURF NDF-129, LYSURF DF-780, LYSURF WS-33AF, LYSURF WS-20KW, and LYSURF WS-30HT, all from LYSURF CHEMICAL Co. AU318C, AU318D, and AU319, all from DEUCHEM Co. and A501 from BYK-Chemie Co. The leveling agent may be employed for a smooth coating surface and to obtain uniform thickness. Suitable leveling agents include, but are not limited to, LYSURF PWJ-26, LYSURF PW-40N, LYSURF PW-40C, LYSURF LB-30, and LYSURF LSA-30G, all from LYSURF CHEMICAL Co. and AU800, AU803, AU812, all from DEUCHEM Co. The thickening agent may be employed to adjust the screen printability of the ink composition. Suitable thickening agents include, but are not limited to, AU151 from DEUCHEM Co., Ltd. Other common additives for printing inks can be present in the protective ink of the invention. Such additives include, for example, 0-2 parts by weight of a wetting agent and/or a penetrating agent. Suitable wetting agents include, but are not limited to, AU958C, AU956, and AU957, all from BYK Co. Suitable penetrating agents include, but are not limited to, LYSTEX KC-143, LYSTEX KC-212, LYSTEX KC-200, LYSTEX KC-1231, and LYSTEX KC-231E, all from LYSURF CHEMICAL Co.

The protective ink may further include 1-5 parts by weight of a colorant, which is useful to increase contrast of the printed pattern and help viewers identify details more easily with the naked eye or under a microscope. The colorant used herein may include pigment, dye, or combinations thereof. When an ink is used for ink-jet printing, the viscosity should be as low as possible, and the thixotropic properties are not required for the ink. However, when the ink is used for screen printing, the screen is easily clogged if the thixotropic index is too high. On the other hand, when the thixotropic index is too low, the edge of the printed pattern becomes ragged. In order to achieve a fine line feature by screen printing, the thixotropic index (TI) of the ink is preferably controlled in the range from about 1 to about 5, more preferably from about 1.2 to about 3.5, and the viscosity is preferably controlled in the range from about 20000 to about 300000 cps (at 25° C.), more preferably from about 25000 to about 160000 cps (at 25° C.). In addition, the solid content of the protective ink is preferably in the range from about 10 to 80, more preferably from about 10 to 70. The protective ink of the invention is suitable for screen printing patterns having a minimum line width and line spacing of not greater than 150 μm. In preferred embodiments, fine line patterns having a minimum line width and line spacing of not greater than 100 μm, or even not greater than 60 μm can be achieved.

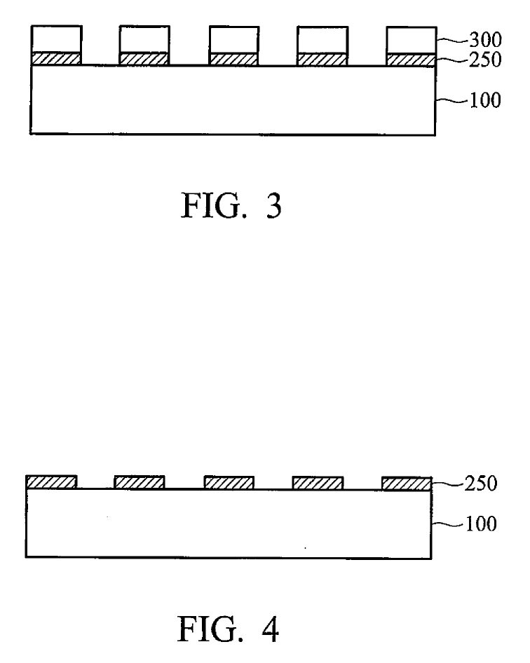

The conductive layer 200 is subjected to etching after the printed protective ink 300 is baked, for example, at 110-150° C. Referring to FIG. 3, using the protective ink 300 as an etch mask, the exposed portions of the conductive layer 200 are removed by etching, thus providing a conductive pattern 250. The etching procedure is preferably performed by wet etching. The etchant is not particularly limited, as long as it provides an etching selectivity between the conductive layer and the protective ink. Examples of suitable etchants include acidic solutions such as aqueous solutions of hydrochloric acid, perchloric acid, carbonic acid, oxalic acid, or acetic acid, and non-acidic solutions such as hydrogen peroxide solutions. Additionally, the etching procedure can be performed by dry etching such as plasma etching, reactive ion etching (RIE), and the like.

Referring to FIG. 4, after the protective ink 300 is stripped from the substrate by solvent, the underlying conductive pattern 250 is revealed. The protective ink of the invention is resistant to etching, but is easily stripped without affecting the underlying pattern. The stripping solvent used herein can be the same or similar solvents used in the protective ink formulation. Thus, conductive patterns having a minimum line width and line spacing of not greater than 150 μm can be fabricated. In preferred embodiments, conductive patterns having a minimum line width and line spacing of not greater than 100 μm or even not greater than 60 μm can be achieved.

The conductive pattern 250 can have any conductive features of flexible electronics, for example, electrodes, circuits, conductive contacts, via plugs, or combinations thereof. The flexible electronics may include, but are not limited to, a flexible printed circuit board, a flexible display, a flexible solar cell, an electronic tag device, or a radio frequency identification (RFID) device. Examples of flexible displays include flexible liquid crystal displays (LCD), field emission displays (FED), organic light emitting devices (OLED), electronic paper (E-paper), electronic book (E-book), and so on.

The fabrication method can be carried out by a continuous roll-to-roll process or a batch process. The materials used in the above method are readily available and the processing steps are much simpler compared to photolithographic methods. The production costs, including the equipment and the materials, is only about ⅓ that of photolithographic methods. In view of the foregoing, it is readily appreciated that the invention provides a simple, low cost fabrication method for forming fine line patterns on a flexible substrate.

Without intending to limit it in any manner, the present invention will be further illustrated by the following examples.

### EXAMPLE 1

An epoxy resin solution was prepared as follows: 15 parts by weight of a bisphenol A epoxy resin (“BE 188”; Chang Chun Petrochemical Co.), 11.6 parts by weight of an epoxy resin (“BE 325”; Chang Chun Petrochemical Co.), and 37.3 parts by weight of a hydroxyl-containing bisphenol A epoxy resin (“BE 500”; Chang Chun Petrochemical Co.) were dissolved in 126 parts by weight of propylene glycol monoethyl ether (PGME), and stirred under nitrogen at 125□ for 4 hours. The mixture was cooled to 80□, and then 9.7 parts by weight of 4,4-diamino diphenyl sulfone (from Echo Chemical Co.) was added and stirred for 120 minutes. After cooling to room temperature, an epoxy resin solution was obtained.

A protective ink was prepared as follows: 91.4 parts by weight of the above prepared epoxy resin solution, 2.05 parts by weight of an anti-tack agent (“LYSURF DF-300”; LYSURF CHEMICAL Co.), 1.05 parts by weight of a defoaming agent (“LYSURF LB-961A”; LYSURF CHEMICAL Co.), 1.5 parts by weight of a leveling agent (“BYK 344”; BYK Co.), 3 parts by weight of a thickening agent (“Vp-2810”; DEUCHEM Co.), and 1 part by weight of blue ink (containing 20% of blue pigment, produced by Industrial Technology Research Institute, Taiwan) were stirred at 80□ for 120 minutes, and then cooled to 50□. 0.05 parts by weight of 2-methylimidazole (from Echo Chemical Co.) was added to the above mixture and stirred at 50□ for 60 minutes, thus resulting in protective ink A with a solid content of about 51%. The composition of protective ink A is listed in Table 1.

TABLE 1
Composition of Protective Ink A

| | | |
|---|---|---|
| Epoxy resin solution | 91.4 | parts by weight |
| Anti-tack agent (BF300) | 2.05 | parts by weight |
| Defoaming agent (961A) | 1.05 | parts by weight |
| Leveling agent (BYK344) | 1.5 | parts by weight |
| Thickening agent (Vp-2810) | 3 | parts by weight |
| Blue ink (20% blue pigment) | 1 | parts by weight |

### EXAMPLE 2

15 parts by weight of vinyl chloride-vinyl acetate-maleic acid terpolymer resin (VMCH) was dissolved in 81.3 parts by weight of ethylene glycol monobutyl ethyl acetate (EGMEA) at 90° C., followed by addition of 0.2 parts by weight of a thickening agent (“BYK 410”; BYK Co.), 1.5 parts by weight of a leveling agent (“BYK 344”; BYK Co.), 1 part by weight of a defoaming agent (“BYK A501”; BYK Co.) and 1 part by weight of blue ink (containing 20% of blue pigment, produced by Industrial Technology Research Institute, Taiwan), thus resulting in protective ink B with a solid content of about 16.4%. The composition of protective ink B is listed in Table 2.

TABLE 2
Composition of Protective Ink B

| | | |
|---|---|---|
| VMCH terpolymer resin | 15 | parts by weight |
| EGMEA | 81.3 | parts by weight |
| Defoaming agent (BYK A501) | 1 | part by weight |
| Leveling agent (BYK 344) | 1.5 | parts by weight |
| Thickening agent (BYK 410) | 0.2 | parts by weight |
| Blue ink (20% blue pigment) | 1 | parts by weight |

### EXAMPLE 3

1 part by weight of blue ink (containing 20% of blue pigment, produced by Industrial Technology Research Institute, Taiwan) was added to 20 parts by weight of a thermoplastic polyurethane elastomer (Estane 5715) and 78.4 part by weight of carbitol acetate(diethylene glycol monoethylether acetate), followed by addition of 0.6 parts by weight of a leveling agent (“BYK 344”; BYK Co.), thus resulting in protective ink C. The composition of protective ink C is listed in Table 3.

TABLE 3
Composition of Protective Ink C

| | | |
|---|---|---|
| Estane 5715 | 20 | parts by weight |
| Carbitol Acetate | 78.4 | parts by weight |
| Leveling agent (BYK344) | 0.6 | parts by weight |
| Blue ink (20% blue pigment) | 1 | parts by weight |

### EXAMPLE 4

50 parts by weight of protective ink B was mixed with 50 parts by weight of protective ink C, thus resulting in protective ink D. The composition of protective ink D is listed in Table 4.

TABLE 4
Composition of Protective Ink D

| | |
|---|---|
| Protective ink B | 50 parts by weight |
| Protective ink C | 50 parts by weight |

### EXAMPLE 5

Protective inks A, B, C, and D, respectively were screen printed on an ITO/PET substrate. After being baked at 150° C. for 25 minutes, the printed substrate was immersed in a 1.7N HCl aqueous solution to remove portions of the ITO not covered by the protective ink. A conductive pattern was obtained after removing the protective ink by solvent stripping. Various properties of the protective inks, including thixotropic index, storage stability, and screen printability, were evaluated and the results are summarized in Table 5.

TABLE 5
Evaluation of Protective Ink

| Physical property | Protective ink A | Protective ink B | Protective ink C | Protective ink D |
|---|---|---|---|---|
| Thixotropic index | 3.16 | 1.25 | 1.3 | 1.3 |
| Storage stability | 45° C./7 days | 45° C./180 days | 45° C./180 days | 45° C./180 days |
| Screen printability | 100 ± 10μ | 150 ± 20μ | 100 ± 10μ | 80 ± 10μ |
| (Resolution) | | | | |
| Screen clogging | No | No | No | No |
| Etch resistance | 90 Sec | 90 Sec | 90 Sec | 90 Sec |
| (1.7N HCL at room | | | | |
| temperature) | | | | |
| Line edge variation* | 9% | 12% | 13% | 12% |
| Stripping solution | PGME | EGMEA | Carbitol Acetate | EGMEA:Carbitol |
| (Sec) | (4 Sec) | (5 Sec) | (3 Sec) | Acetate = 1:1 |
| | | | | (6 Sec) |

*Line edge variation was the average of ten points measured under microscope at 60 times magnification

As shown in Table 5, the protective ink of the invention exhibited superior screen printing properties, etching resistance, as well as strippability. With the present invention, fine line conductive patterns can be fabricated by a simple, cost-effective method, which can be easily integrated into a continuous roll-to-roll process.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for fabricating a conductive pattern on a flexible substrate, comprising:
providing a flexible substrate having a conductive layer thereon;
screen printing a protective ink on the conductive layer, wherein a portion of the conductive layer is exposed through the protective ink;
etching to remove the exposed portion of the conductive layer using the protective ink as an etch mask; and
removing the protective layer from reminder of the conductive layer, thus providing a conductive pattern, wherein the conductive pattern has a minimum line width of not greater than 150 μm.

2. The method as claimed in claim 1, wherein the flexible substrate comprises polymer, organic/inorganic hybrid material, organic/inorganic composite, paper, non-woven fabric, cloth, thin glass, sol gel or metallic foil.

3. The method as claimed in claim 1, wherein the flexible substrate comprises polyester, polyimide, polycarbonate, polyethylene, polypropylene, polyvinyl alcohol, polyvinyl phenol, poly(methylmethacrylate), poly(ethylene terephthalate), poly(ethylene naphthalate), parylene, epoxy resin, or polyvinyl chloride.

4. The method as claimed in claim 1, wherein the etching is performed by wet etching.

5. The method as claimed in claim 1, wherein the conductive pattern is fabricated by a continuous roll-to-roll process or a batch process.

6. The method as claimed in claim 1, wherein the conductive layer comprises metals, metal oxides, alloys thereof, or laminates thereof.

7. The method as claimed in claim 1, wherein the conductive layer comprises copper, aluminum, gold, silver, nickel, titanium, platinum, tungsten, cobalt, tantalum, molybdenum, tin, indium tin oxide (ITO), indium zinc oxide (IZO), alloys thereof, or laminates thereof.

8. The method as claimed in claim 1, wherein the conductive pattern comprises electrodes, circuits, conductive contacts, via plugs, or combinations thereof.

9. The method as claimed in claim 1, wherein the conductive pattern has a minimum line width of not greater than 100 μm.

10. The method as claimed in claim 1, wherein the conductive pattern is a conductive element for a flexible printed circuit board, a flexible display, a flexible solar cell, an electronic tag device, or a radio frequency identification (RFID) device.

11. The method as claimed in claim 1, wherein the protective ink comprises 10-80 parts by weight of a polymer resin, 0-5 parts by weight of an anti-tack agent, 0-3 parts by weight of a defoaming agent, 0.1-5 parts by weight of a leveling agent, 0.1-5 parts by weight of a thickening agent, and 20-90 parts by weight of a solvent.

12. The method as claimed in claim 11, wherein the protective ink has a thixotropic index (TI) of about 1.1-5.

13. The method as claimed in claim 11, wherein the protective ink further comprises 1-5 parts by weight of a colorant.

14. The method as claimed in claim 11, wherein the polymer resin comprises epoxy resins, vinyl resins, polyurethane resins, thermoplastic polyurethane (TPU) elastomers, acrylic resins, or combinations thereof.

15. The method as claimed in claim 14, wherein the epoxy resins comprise bisphenol A epoxy resins, bisphenol F epoxy resins, bisphenol S epoxy resins, phenol-novolak epoxy resins, cresol-novolak epoxy resins, alicyclic epoxy resins, or combinations thereof.

16. The method as claimed in claim 14, wherein the vinyl resins comprise vinyl acetate polymer resins, vinyl chloride-vinyl acetate copolymer resins, vinyl chloride-vinyl acetate-maleic acid terpolymer resins, or combinations thereof.

17. The method as claimed in claim 11, wherein the protective ink has a solid content of about 10-80 weight percent.

18. The method as claimed in claim 11, wherein the protective ink has a viscosity of about 20000-300000 cps at 25° C.

19. A protective ink, comprising:
10-80 parts by weight of a polymer resin;
0-5 parts by weight of an anti-tack agent;
0-3 parts by weight of a defoaming agent;
0.1-5 parts by weight of a leveling agent;
0.1-5 parts by weight of a thickening agent; and
20-90 parts by weight of a solvent,
wherein the protective ink has a thixotropic index (TI) of about 1.1-5.

20. The protective ink as claimed in claim 19, wherein the polymer resin comprises epoxy resins, vinyl resins, polyurethane resins, thermoplastic polyurethane (TPU) elastomers, acrylic resins, or combinations thereof.

21. The protective ink as claimed in claim 20, wherein the epoxy resins comprise bisphenol A epoxy resins, bisphenol F epoxy resins, bisphenol S epoxy resins, phenol-novolak epoxy resins, cresol-novolak epoxy resins, alicyclic epoxy resins, or combinations thereof.

22. The protective ink as claimed in claim 20, wherein the vinyl resins comprise vinyl acetate polymer resin, vinyl chloride-vinyl acetate copolymer resin, vinyl chloride-vinyl acetate-maleic acid terpolymer resin, or combinations thereof.

23. The protective ink as claimed in claim 19, wherein the protective ink has a solid content of about 10-80 weight percent.

24. The protective ink as claimed in claim 19, further comprising 1-5 parts by weight of a colorant.
